(19) United States
(12) Patent Application Publication
(10) Pub. No.: US 2024/0012804 A1
(43) Pub. Date: Jan. 11, 2024

(54) Computer-Implemented Method for Storing a Dataset and Computer Network

(71) Applicant: Siemens Aktiengesellschaft, München (DE)

(72) Inventors: Saurabh Narayan Singh, München, Bayern (DE); Nejc Zupan, München (DE); Tobias Aigner, München (DE); Markus Sauer, München (DE)

(73) Assignee: Siemens Aktiengesellschaft, München (DE)

(21) Appl. No.: 18/042,954

(22) PCT Filed: Aug. 26, 2021
(86) PCT No.: PCT/EP2021/073560

§ 371 Date: Feb. 24, 2023

(30) Foreign Application Priority Data
Aug. 28, 2020 (EP) 20193405.6

(51) Int. Cl. G06F 16/23; G06F 16/27

(52) U.S. Cl. CPC G06F 16/2365; G06F 16/27

(57) ABSTRACT

Various embodiments include a computer-implemented method for storing a dataset with two or more nodes of a comput¬er network. The method may include: splitting the dataset into two or more shards; storing a first shard with two nodes redundantly; checking an integrity of the first shard in at least one of the two nodes; and if the check shows a lack of integrity, storing the first shard redundantly again.

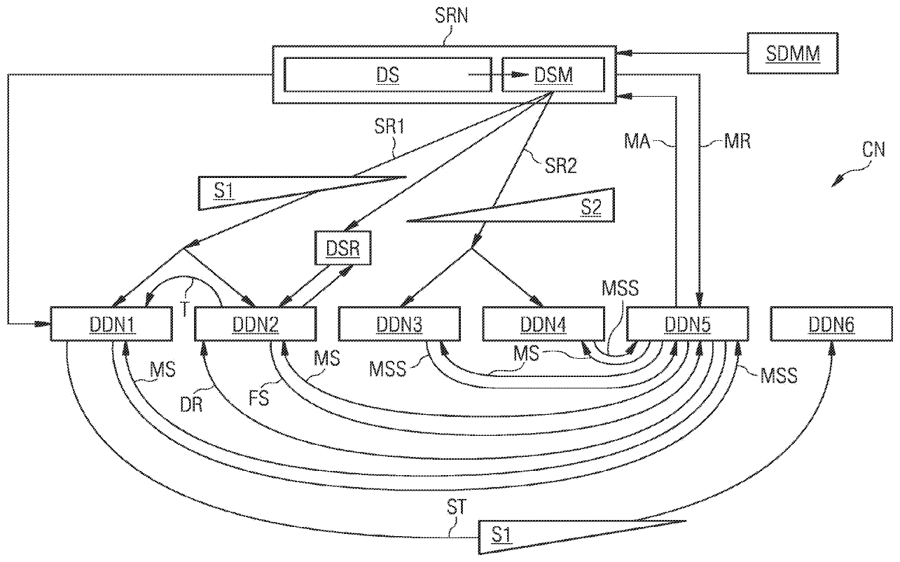

### CROSS-REFERENCE TO RELATED APPLICATIONS

This application is a U.S. National Stage Application of International Application No. PCT/EP2021/073560 filed Aug. 26, 2021, which designates the United States of America, and claims priority to EP Application No. 20193405.6 filed Aug. 28, 2020, the contents of which are hereby incorporated by reference in their entirety.

### TECHNICAL FIELD

The present disclosure relates to computer networks. Various embodiments of the teachings herein include methods and/or systems for storing a dataset with two or more nodes of a computer network.

### BACKGROUND

In various technical applications, particularly within the area of the so-called internet-of-things (IoT), datasets are stored in distributed databases across whole computer networks, that comprise a multitude of network nodes. In such distributed databases, the ownership of data of the database may be decentralized and the dataset maybe replicated across nodes of the network. However, not all data can be replicated over all nodes of the network, since the scalability of such an architecture would be severely limited.

It is typical to split datasets into shards and distribute the shards across different nodes based on a defined algorithm logically and depending on potential failure scenarios. Particularly, nodes in different physical locations or on different operating hardware or nodes owned by different independent legal entities are commonly chosen. With such diverse choices for the nodes, the exposure to single conditions of failure is reduced and the reliability of the storage of the dataset is increased.

The last aspect holds especially true for typical blockchain scenarios where trustless scenarios rely on jointly operated distributed databases. Particularly in such scenarios, consistency and tamperproof operation must be secured through cryptographic measures.

Nevertheless, it is still challenging to ensure data availability of datasets in distributed databases subject to decentralized ownership. In a centralized or distributed system governed by a single entity, this problem can be addressed by existing solutions. In distributed database deployed in a federated environment, in contrast, datasets of the database may be split into shards and distributed across nodes that are not centrally operated. Since certain nodes may become suddenly unavailable and not all the nodes store all shards of the datasets, the availability of data of the database cannot be guaranteed. In case data availability and consistency had to be guaranteed, e.g. for certification proofs, datasets must be recoverable for long time periods.

### SUMMARY

Thus, the present disclosure includes various methods for storing a dataset with nodes of a computer network. Some embodiments of the teachings herein improve availability of datasets that are distributed across a computer network consisting of several and not necessarily jointly operated nodes. For example, some embodiments include a computer-implemented method for storing a dataset (DS) with two or more nodes (SRN, DDN1, DDN2, DDN3, DDN4, DDN5, DDN6) of a comput¬er network (CN), in which the dataset (DS) is split into two or more shards (S1, S2), characterized in that at least one shard (S1) is stored with at least two nodes (DDN1, DDN2) redundantly, wherein an integrity of the shard (S1) of one node (DDN2) is subject to a check and wherein, if the check shows a lack of integrity, the shard (S1) is redundantly stored again.

In some embodiments, the method is carried out for more than one, e.g. for each, shard (S1, S2) of the dataset (DS).

In some embodiments, each of the at least two or more shards (S1, S2) comprises only a part of the dataset (DS) and not the whole dataset (DS).

In some embodiments, the integrity of the shard (S1) comprises an identity of the shard (Dl) and/or a presence of the shard (S1) and/or a current status of a storage of the shard (S1).

In some embodiments, the shard (S1) is stored redundantly again with a node (DDN6), that is different from that node (DDN2) that currently stores the shard (S1) whose integrity of the shard (S1) is checked.

In some embodiments, the integrity is checked using a hash value of the shard (S1).

In some embodiments, the check of the integrity is triggered with a node (DDN5), that is different from that node (DDN2) that stores the shard (S1) whose integrity is checked.

In some embodiments, the check of the integrity is checked by a node (DDN5) and wherein the shard (S1) is redundantly stored again with a node (DDN6) different from that node (DDN5) that triggers the check of the integrity.

In some embodiments, at least one of the shards (S1) is stored with a true subset of the nodes (DDN1, DDN2).

In some embodiments, the subsets are different pairwise.

As another example, some embodiments include a computer-network configured to carry out one or more of the methods described herein.

### BRIEF DESCRIPTION OF THE DRAWINGS

In the following, example embodiments of the teachings herein shown in the drawings will be explained in more detail.

The FIGURE shows a computer network incorporating teachings of the present disclosure configured to carry out one or more of the methods described herein.

### DETAILED DESCRIPTION

The computer-implemented methods incorporating the teachings of the present disclosure include storing a dataset with two or more nodes of a computer network. In some embodiments, the dataset is a dataset of a distributed database and/or the dataset is stored in a distributed database distributed on or across the two or more nodes of the computer network. In some embodiments, the dataset is split into two or more shards, wherein one shard is stored with at least two nodes redundantly, wherein an integrity of the shard of one node is subject to a check and the shard is redundantly stored again if the check shows a lack of integrity. The phrase “shard stored with a node” means that the shard is stored with a resource that is attributed to the node, such as a storage of the node or a storage associated with the node, such as an external and/or cloud storage attributed to the node, particularly an external and/or cloud storage, whose access is controlled by the node.

In some embodiments, each of the at least two or more shards comprises only a part of the dataset. In other words, each of the at least two or more shards does not contain the whole dataset. In some embodiments, the nodes of the computer network are, either indirectly or ideally directly, connected to each other, particularly via internet and/or wirelessly and/or wire based. Although a multitude of shards may be involved, in case the shard is referred to as a single shard it is typically always one and the same shard unless otherwise noted.

The methods described herein provide a pro-active health monitoring system which addresses the current issues associated with the state of the art. Particularly the integrity of datasets can be guaranteed for long periods of time via proactive redundant storage of parts of datasets that may be subject to data losses. The methods utilize checks of the integrity of shards of datasets and triggers necessary redundant storage of the shards automatically. Accordingly, a persistence and long-term availability of stored datasets can be realized even without a storage of the whole dataset on each node of the computer network.

The methods do not necessarily involve a storage of the whole dataset in all nodes of the computer network. Thus, the methods are highly scalable with the size, i.e. the number of nodes, of the computer network.

In some embodiments, the additional redundant storage of the shards applies only to those shards, where the redundancy of the shard is in question. Thus, not the full dataset has to be stored redundantly, but only the affected shard of the dataset. Thus, the efforts spent for data transfer and storage can be kept to a minimum.

In some embodiments, the availability and consistency of datasets that are decomposed and distributed over multiple nodes can be guaranteed by applying pro-active health monitoring and deriving and executing measures to guarantee defined health metrics in a certain range for datasets consisting of distributed shards.

In some embodiments, the steps of storing the shard with at least two nodes redundantly, the integrity of the shard being subject to a check and redundantly storing the shard again if the check shows a lack of integrity, are carried out for all shards of the dataset. The integrity of the full dataset can be guaranteed with a high reliability. Thus, the dataset can be fully and reliably recovered after long periods of time. Thus, the method according to the invention is highly suitable for long-term applications.

In some embodiments, the integrity of the shard comprises an identity of the shard and/or a presence of the shard and/or a current status of a storage of the shard. The integrity check involves in a first alternative the identity of the shard, meaning that the shard has not been altered in a past time period. Particularly, the identity of the shard may be assessed with calculating a one-way function such as a function resulting in a hash value of the shard and comparing the result of the one-way function with a previously calculated result. In a preferred aspect, the identity may be deduced if the results of the one-way function calculation do not deviate, e.g. if hash values of the shard do not deviate from previously evaluated hash values. In a further aspect of the invention, the integrity of the shard may mean that the shard remains available in a data storage. E.g. in case the shard cannot be retrieved from a data storage, the integrity of the shard may be considered lacking. Additionally, or alternatively, the integrity of the shard may be represented by a current status of a storage of the shard. Particularly if a time span of operation of a storage medium exceeds a certain threshold, the storage medium may be considered as not sufficiently reliable anymore and an additional redundant storage of the shard may be considered necessary. Furthermore, the integrity may refer to a reliability of an external storage provider such as a cloud storage provider. Particularly, the current status of the storage may mean a current backup-routine for backing up data by an external provider, which may change over time and could be treated as not sufficiently reliable in case the backup-routine does not satisfy needs, particularly in terms of redundancy.

In some embodiments, the shard is stored redundantly again with a node, that is different from that node whose shard is subject to the check of integrity. Single conditions of failure of the respective node, such as misconfigured software or inexperienced operation may be avoided if such conditions contribute to a lack of integrity. Accordingly, a risk of further data loss can be mitigated.

In some embodiments, the integrity is checked using a hash value of the shard. As described above, a hash value of the shard may be used to confirm the identity of the shard with a supposedly identical earlier version of the shard.

In some embodiments, the check of the integrity is triggered with a node, that is different from that node whose shard is subject to the check of integrity. In this case, the method does not necessarily rely on the functionality of the node whose shard may exhibit a lack of integrity.

In some embodiments, the shard is redundantly stored again with a node different from that node that triggered the check of the integrity. The functional roles of the nodes for the method are played by different nodes, so that possible issues present on one node do not interfere with carrying out method steps on other nodes.

In some embodiments, at least one of the shards is stored with a true subset of the nodes. Not every node needs to store the full dataset in its entirety. Thus, the application of the method remains scalable since storage requirements do not necessarily grow extensively with an increase of the number of nodes of the computer network.

In some embodiments, the subsets are different pairwise. A certain diversity of nodes storing the shards is guaranteed. Thus, the method may be less vulnerable to certain risks particularly associated with a subset of the nodes of the computer network.

In some embodiments, a computer network incorporating teachings of the present disclosure is configured to carry out one or more of the methods described herein. E.g. the computer network may comprise a data storing registry, that stores an ID of the shards and/or a hash value of the shard and/or the node or nodes, the shard is stored with and/or communication signals for agreeing on the storage of the respective shard. In some embodiments, the nodes, that store shards of the dataset, may comprise shard storage modules for storing the shards and/or shard monitoring and checking modules for monitoring and checking the integrity of the shards and/or shard recovery modules for recovering the shards.

In some embodiments, nodes that request storage of shards may comprise a data to shards module that decomposes a dataset into shards and/or a shard distribution and management module that determines the distribution and management of shards to other nodes of the computer network.

In some embodiments, all previously mentioned modules such as the data storing registry and/or the shard storing module/s and/or the shard monitoring and checking module/s and/or the shard recovery module/s and/or the data to shards module/s and/or the shard distribution and management module/s may be realized as software modules configured to carry out the tasks mentioned above.

In some embodiments, the computer network may be a communication network. The computer network CN shown in the FIGURE is a communication network and comprises a multitude of connected nodes SRN, DDN1, DDN2, DDN3, DDN4, DDN5, DDN6, which are each realized as individual computers that operate a software to carry out the method according to the invention.

One node SRN of the nodes SRN, DDN1, DDN2, DDN3, DDN4, DDN5, DDN6 of the computer network CN is faced with the task of storing a dataset DS in a database utilizing the nodes DDN1, DDN2, DDN3, DDN4, DDN5, DDN6 of the computer network CN. This means, the nodes DDN1, DDN2, DDN3, DDN4, DDN5, DDN6 of the computer network CN are requested to provide the storage resources for storing the dataset DS. The node SRN requesting storage for the dataset DS is referred to as a storage requesting node SRN in what follows.

In a first step, the storage requesting node SRN sets up a splitting of the dataset DS into shards. In order to split the dataset DS, the storage requesting node SRN requests particular instructions in form of a sharding algorithm, which are centrally stored in the computer network CN in a shard distribution and management module SDMM, which is realized as a software module running for instance on a separate server In other embodiments, the shard distribution and management module may run on a node or may be distributed across more or all nodes, so that the shard distribution and management module runs in a decentralized fashion. The shard distribution and management module SDMM additionally transmits a set of parameters for the sharding algorithm that comprise additional conditions for sharding, namely how many times the shard should be stored redundantly on different nodes, how many nodes will monitor an integrity of the shards and a minimum shard size, how shards should be distributed across the computer network and optionally a level of intended hardware difference between storage nodes DDN1, DDN2, DDN3, DDN4, DDN5, DDN6.

The storage requesting node SRN splits the dataset DS of the database into shards according to the algorithm received by the shard distribution and management module SDMM. The storage requesting node SRN comprises a data-to-shards-module DSM, which is realized as a software module running on the storage requesting node SRN. The data-to-shards-module DSM performs the splitting of the dataset DS. In the embodiment depicted in the FIGURE, the dataset DS is split into two shards, a first shard S1 and a second shard S2, for reasons of illustration. In reality, the number of shards is typically of the same order of magnitude as the number of nodes SRN, DDN1, DDN2, DDN3, DDN4, DDN5, DDN6 of the computer network CN, but truly lower than this number, so that only a true subset of nodes SRN, DDN1, DDN2, DDN3, DDN4, DDN5, DDN6 stores shards of the dataset DS.

Within the algorithm provided by the shard distribution and management module SDMM the storage requesting node SRN received instructions for the distribution of the first shard S1 and the second shard S2. The storage requesting node SRN distributes the first S1 and second shard S2 according to these instructions.

The nodes DDN1, DDN2 receive storage requests SR1 for the first shard S1 and the nodes DDN3, DDN4 receive storage requests SR2 for the second shard S2, respectively.

Each node DDN1, DDN2, DDN3, DDN4 stores the respective first S1 or second shard S2 and returns an acknowledgment signal (including a hash signed with a private key of the Nodes DDN) or rejects the request. The acknowledgement signals are not explicitly shown in the FIGURE.

The acknowledgement signals by each node DDN1, DDN2, DDN3, DDN4 and addresses of the storing Nodes DDN1, DDN2, DDN3, DDN4 for the first S1 and second shards S2 of the dataset DS are stored in a data storing registry DSR in order to easily retrieve the dataset DS again for rebuilding the dataset DS from the first S1 and second shard S2. The data storing registry DSR can for instance be realized in central fashion but also as distributed system across multiple systems.

For each acknowledgment of a stored first S1 or second shard S2, storage requesting node SRN sends out monitoring requests that contain a shard ID of the shard, signed hashes of the shard storage acknowledgements and an address of the storage locations. In the depicted embodiment of a computer network CN in form of a communication network, the addresses of the shards are represented as communication addresses. In the situation depicted in the FIGURE, a monitoring request MR is sent out to the node DDN5, which does not store the first S1 and the second shard S2. The monitoring request MR requests monitoring the storage of the first S1 and second shard S2 on the nodes DDN1, DDN2, DDN3, DDN4.

DDN5 responds to the monitoring request MR with an acknowledgment signal MA and starts monitoring the storage of the first S1 and second shard S2 on the nodes DDN1, DDN2, DDN3, DDN4.

In order to monitor the storage of the first S1 and second shard S2 on the nodes DDN1, DDN2, DDN3, DDN4, the node DDN5 sends out a monitoring signal MS with a shard ID of the respective first S1 or second shard S2 and a hash of the respective first S1 or second shard S2 to the respective nodes DDN1, DDN2, DDN3, DDN4.

The nodes DDN1, DDN2, DDN3, DDN4 look up the first S1 or second shard S2, respectively, in their respective storage and calculate the hash of the respective first S1 or second shard S2 and compare the hash with the hash contained in the monitoring signal MS.

If the calculated hash and the hash in the monitoring signal MS match, the storing nodes DDN1, DDN3, DDN4 send back a confirmation signal MSS to the monitoring node DDN5, that indicates that an integrity of the stored first S1 or second shard S2, respectively, is confirmed. In these cases, the monitoring node DDN5 continues with its monitoring according to defined policies.

In case the calculated hash and the hash in the monitoring signal MS do not match, which in the depicted embodiment is exemplarily shown for the node DDN2 in the FIGURE, the node DDN2 sends back a failure signal FS that indicates a lack of integrity of the stored first shard S1.

Accordingly, the monitoring node DDN5 sends out a replication request DR to the storing node DDN2. The storing node DDN2 comprises a shard recovery module (not explicitly shown in the FIGURE) for recovering the first shard S1. The shard recovery module of the storing node DDN2 may be realized with a software module.

If the storing node DDN2 receives the replication request DR for its stored first shard S1, its shard recovery module SRM of the storing node DDN2 checks (in the embodiment depicted in the FIGURE via consultation of the data storing registry DSR) which other storing node DDN1 stores a copy of this shard and which other node DDN6 are available.

The shard recovery module of the storing node DDN2 generates a new storage request to other node DDN6 not being involved in storage or monitoring of the corresponding dataset DS and requests storing node DDN1 with a triggering signal T to send a copy of the first shard S1 stored by storing node DDN1 to the other node DDN6 with a shard transfer signal ST.

On receiving a positive shard storage acknowledgement signal, the shard recovery module of storing node DDN2 validates that all storage and monitoring policies for this shard are now fully met again and synchronizes this information with the monitoring node DDN5. If this is the case, phase 2 continues. Otherwise, shard recovery continuous.

In another embodiment, the data storing registry DSR used for storing acknowledgment messages and addresses of the storing Node DDN1, DDN2, DDN3, DDN4, DDN6 storing shards can be implemented as a distributed, decentralized database.

What is claimed is:

1. A computer-implemented method for storing a dataset with two or more nodes of a comput¬er network, the method comprising:
splitting the dataset into two or more shards;
storing a first shard with two nodes redundantly;
checking an integrity of the first shard in at least one of the two nodes; and
if the check shows a lack of integrity, storing the first shard redundantly again.

2. A method according to claim 1, further comprising:
storing a second shard with at least two nodes redundantly;
checking an integrity of the second shard in at least one of the at least two nodes; and
if the check shows a lack of integrity, storing the second shard redundantly again.

3. A method according to claim 1, wherein each of the two or more shards comprises only a part of the dataset and not the whole dataset.

4. A method according to claim 1, wherein the integrity of any shard comprises an identity and/or a presence and/or a current status of a storage of the respective shard.

5. A method according to claim 1, wherein the first shard is stored redundantly again with a node separate from the at least one of the two nodes.

6. A method according to claim 1, wherein checking the integrity is includes using a hash value of the shard.

7. A method according to claim 1, wherein the check of the integrity is triggered with a node separate from the at least one of the two nodes.

8. A method according to claim 1, wherein:
the check of the integrity is checked by a node separate from the at least one of the two nodes; and
the shard is redundantly stored again with a node separate from the node that triggers the integrity check.

9. A method according to claim 1, wherein at least one of the shards is stored with a true subset of the nodes.

10. A method according to claim 1, wherein the subsets are different pairwise.

11. (canceled)
